(19) United States
(12) Patent Application Publication
(10) Pub. No.: US 2003/0037597 A1
(43) Pub. Date: Feb. 27, 2003

(54) Method and apparatus for leak testing a liquid system

(76) Inventor: James A. Tarara, Westford, MA (US)

Correspondence Address: JOHN E. TOUPAL, 116 CONCORD STREET, FRAMINGHAM, MA, 01701

(21) Appl. No.: 09/934,089

(22) Filed: Aug. 22, 2001

(51) Int. Cl. G01M 3/08

(52) U.S. Cl. 73/40.5 R

(57) ABSTRACT

A liquid drainage system leak detection apparatus including a cap for closing a port in the drainage system and defining at least a liquid fill opening for communicating therewith; a liquid fill coupling connected to the cap and communicating with the liquid fill opening; a liquid pressure gauge communicating with the drainage system via the cap and adapted to monitor liquid pressure in the drainage system; and a shut off valve disposed between the fill coupling and the fill opening.

### BACKGROUND OF THE INVENTION

This invention relates generally to a method and apparatus for leak testing a liquid drainage system, and, more particularly to an above ground multiple level drainage system.

During the construction of single and multi-story buildings, the plumbing codes require the plumber to run a pressure test on the installed plumbing lines to make certain that they do not leak. Conventionally, the plumbing line has a Y or T connection adjacent its lower end enabling access for periodic cleaning. Advantage is taken of the access opening thus provided for insertion of the testing apparatus.

Such apparatus comprises a plug which is placed removably in the soil pipe in sealed relation thereto. The pipe above the plug then is filled with water, to a height of 3 or 4 stories in a multi-storied building, and the plumbing inspected for leaks. At the conclusion of the test the plug is rendered inoperative, the system drained, and the plug removed. Such conventional leak testing procedures are both cumbersome and hazardous, especially during inclement weather conditions.

The object of the invention, therefore, is to provide a safer more convenient method of leak testing multiple level drainage systems.

### SUMMARY OF THE INVENTION

The invention is a liquid drainage system leak detection apparatus including a cap for closing a port in the drainage system and defining at least a liquid fill opening for communicating therewith; a liquid fill coupling connected to the cap and communicating with the liquid fill opening; a liquid pressure gauge communicating with the drainage system via the cap and adapted to monitor liquid pressure in the drainage system; and a shut off valve disposed between the fill coupling and fill opening. Use of the fill coupling to fill the drainage system greatly simplifies and enhances safety during leak testing thereof.

According to one feature of the invention, the apparatus includes a tubulation connected to the fill opening and terminating with the liquid fill coupling, and the shut off valve and the liquid pressure gauge are disposed in the tubulation between the fill coupling and the fill opening. The tubulation consolidates the components of the apparatus.

According to another feature of the invention, the apparatus includes a pressure regulator disposed in the tubulation between the fill coupling and the fill opening. The regulator simplifies filling of the system from high pressure sources.

According to additional features of the apparatus, the cap further defines a drain opening for communicating with the drainage system and includes a drain coupling connected to the drain opening, and a cut off valve disposed between the drain coupling and the drain opening. These features facilitate drainage of the system after completion of a test.

According to a further feature of the invention, each of the fill coupling and drain coupling is a hose coupling. The hose couplings facilitate filling and draining of the system with a garden hose.

According to still another feature of the invention, the cap is a cup having a hollow cylindrical portion for engaging surface portions of a pipe defining the port, and a cover portion for covering the port and defining the fill and drain openings. The cup simplifies connection of the apparatus to the drainage system.

According to yet other features of the invention, the cup is a resilient member secured to the surface portions of a pipe defining the port by a clamp, the cover portion includes a tubular fill connector portion defining the fill opening which faces one direction and the drain opening faces another direction transverse to the one direction. These features further simplify use of the apparatus during a leak test.

According to an important feature, the apparatus includes a cover for closing an opening at the most elevated position of the drainage system, the cover including an open ended transparent tube communicating with the drainage system. The transparent tube permits venting of the system and visual inspection of the leak test results.

The invention also encompasses a method for leak testing a liquid drainage system and including the steps of providing both a liquid pressure gauge and a cap defining a liquid fill opening and supporting a liquid fill coupling communicating with the liquid fill opening; closing a port in the liquid drainage system with the cap; attaching a liquid source to the liquid fill opening; filling the liquid drainage system through the liquid fill opening while monitoring said liquid pressure gauge to establish a predetermined liquid pressure in the system; and monitoring said liquid pressure gauge to detect leaks in the system indicated by a decrease in liquid pressure therein.

According to other features of the method above, the cap also defines a liquid drain opening and further supports a shut off valve disposed between the fill coupling and the fill opening; and the method includes the steps of closing the shut off valve when the predetermined liquid pressure is reached, and draining the system through the drain opening after the monitoring step is completed.

### BRIEF DESCRIPTION OF THE DRAWINGS

These and other objects and features of the invention will become more apparent upon a perusal of the following description taken in conjunction with the accompanying drawings wherein:

FIG. 1 is an elevational view of a liquid leak testing system applied to a multi-level liquid drainage pipe network;

FIG. 2 is a detailed view of a fill and drain assembly used in the system of FIG. 1; and

FIG. 3 is a cross-sectional view of a cap portion of the fill and drain assembly shown in FIG. 2.

### DESCRIPTION OF THE PREFERRED EMBODIMENTS

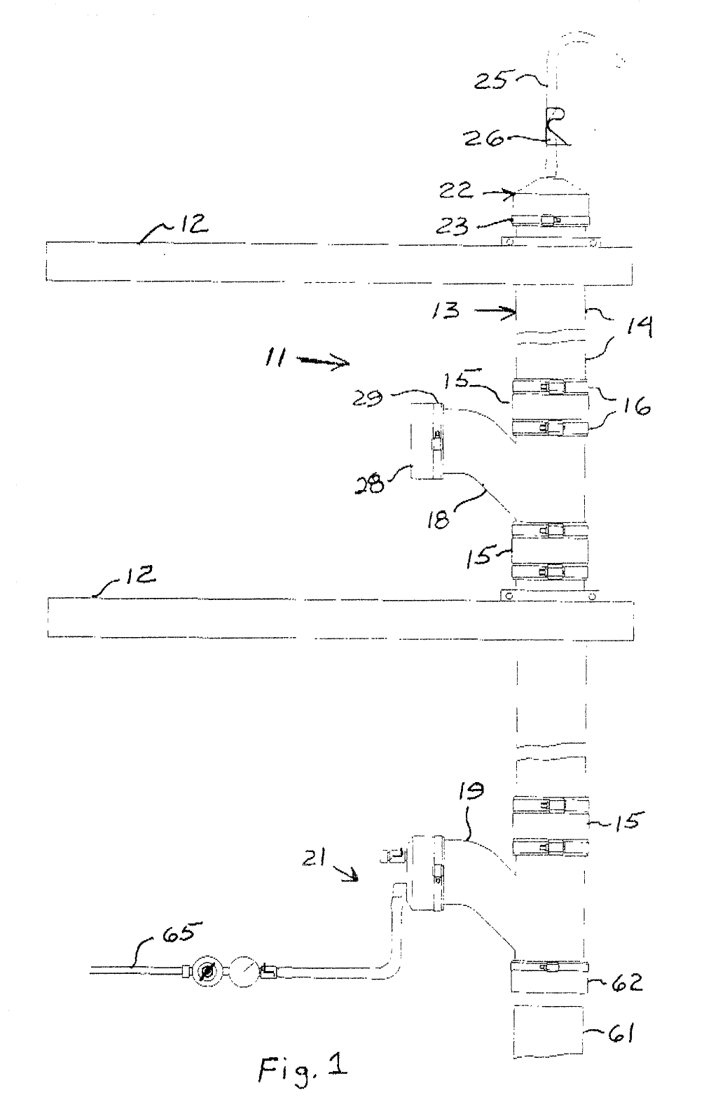

Illustrated in FIG. 1 is a multiple level liquid drainage system 11 installed, for example, in a building having multiple floors 12. It will be understood that the drainage system 11 can represent the entire drainage system of a multiple story building or one vertical segment of a drainage system for a high rise building consisting of many stories. The system 11 includes a stack 13 formed by multiple drain pipes 14 extending between and through the floors 12 and joined by conventional couplings 15 secured with worm-drive hose clamps 16. Projecting from the stack 13 at each level of the building under test is a conventional drainage fitting 18, 19 adapted for subsequent connection to an entire drainage network at that level. Covering a drainage port 20 of the drainage fitting 19 at the lowest position of the system under test is a fill and drain assembly 21 described below. The most elevated position of the stack 13 of the system under test is covered by a cylindrical vent cover 22 secured by a worm-drive hose clamp 23. Extending out of the vent cover 22 is a flexible, transparent tube 25 which can be opened or closed by a clamp 26. All intermediate drainage fittings 18 of the system under test are sealed with conventional cup shaped caps 28 secured with hose clamps 29.

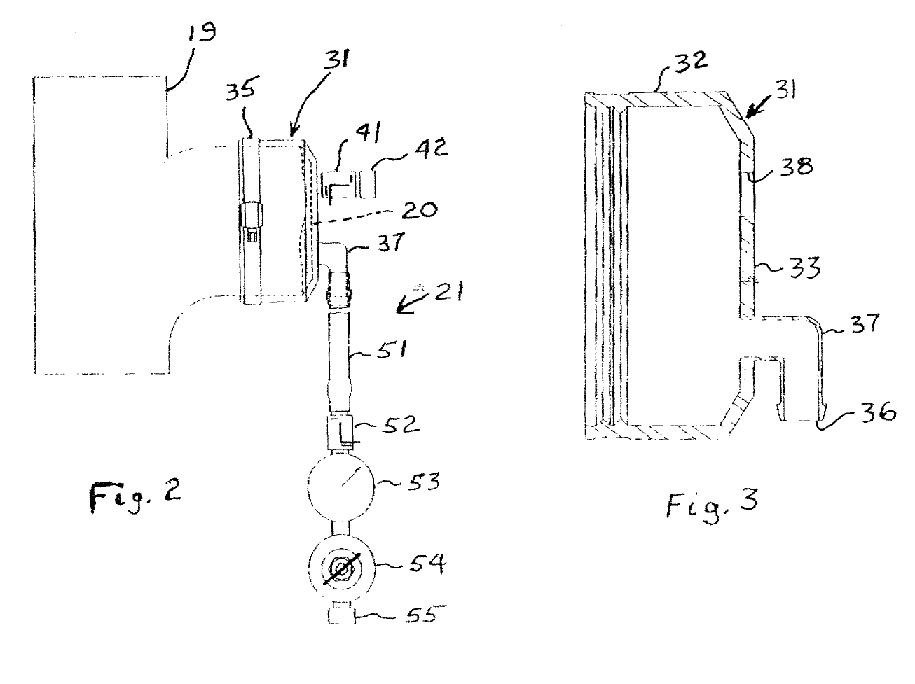

Shown in FIG. 2 is the fill and drain assembly 21 which includes a resilient cup shaped cap 31 (FIG. 3) having a hollow cylindrical portion 32 and a cover portion 33. The cylindrical portion 32 is secured to the outer perimeter of the fitting 19 with a hose clamp 35 and the cover portion 33 covers the drainage port 20 and defines a drain opening 38, and a fill opening 36 terminating an elbow shaped tube 37. Inserted into the drain opening 38 is a drainage cut off valve 41 connected to a drain hose coupling 42 and extending orthogonally from the cover portion 33. The elbow tube 37 projects transversely to the drainage valve 41 and coupling 42.

One end of a flexible tube 51 is fitted over the elbow tube 37 of the cap 31 and an opposite end receives in series a shut off valve 52, a liquid pressure gauge 53, a pressure regulator 54 and a liquid fill hose coupling 55. The drain coupling 42 communicates with the drainage system via the drain opening 38 in the cap 31. Similarly, the shut off valve 52, liquid pressure gauge 53, pressure regulator 54 and liquid fill hose coupling 55 communicate with the drainage system via the fill opening 36 in the tube 37 of the cap 31.

During use of the test assembly 21, the fitting 19 is normally separated from lower portions 61 of the stack 13 and a plain end cap 62 is installed to seal off the upper portion of the system 11 to be tested. The fill and drain assembly 21 then is assembled to the lowest fitting 19 in the stack 13. An ordinary garden hose 65 or other water supply hose is attached to the pressure regulator 54 with the valve 41 in the closed position. This allows filling the system 11 with water from the ground floor or at each floor of the system being tested, while allowing all air in the system to escape through the tube 25. When water flows out of the tube 25, the water is turned off and the pressure observed at the pressure gage 53. Any loss of pressure would indicate a leak in the system. By filling from the ground floor or at each floor being tested, instead of from the top of the system, which might require the use of a ladder or scaffolding, the test is rendered much safer, faster, and more convenient. After the test has been completed, the valve 41 is opened allowing the water to drain out of the system. Another hose (not shown) could be attached to coupling 42 to convey the water being drained into a convenient, safe area where the water will not be a slip hazard.

Obviously, many modifications and variations of the present invention are possible in light of the above teachings. It is to be understood, therefore, that the invention can be practiced otherwise than as specifically described.

What is claimed is:

1. Apparatus for leak testing a liquid drainage system and comprising:
cap means for closing a port in the drainage system, said cap means defining at least a liquid fill opening for communicating with the drainage system;
a liquid fill coupling connected to said cap means and communicating with said liquid fill opening;
a liquid pressure gauge communicating with the drainage system via said cap means and adapted to monitor liquid pressure in the drainage system; and
a shut off valve disposed between said fill coupling and said fill opening.

2. Apparatus according to claim 1 including a tubulation connected to said fill opening and terminating with said liquid fill coupling, and wherein said shut off valve and said liquid pressure gauge are disposed in said tubulation between said fill coupling and said fill opening.

3. Apparatus according to claim 2 including a pressure regulator disposed in said tubulation between said fill coupling and said fill opening.

4. Apparatus according to claim 3 wherein said cap means further defines a drain opening for communicating with the drainage system; and including a drain coupling connected to said drain opening.

5. Apparatus according to claim 4 including a cut off valve disposed between said drain coupling and said drain opening.

6. Apparatus according to claim 5 wherein each of said fill coupling and said drain coupling is a hose coupling.

7. Apparatus according to claim 1 wherein said cap means further defines a drain opening for communicating with the drainage system; and including a drain coupling connected to said drain opening.

8. Apparatus according to claim 7 including a cut off valve disposed between said drain coupling and said drain opening.

9. Apparatus according to claim 1 wherein said cap means is a cup having a hollow cylindrical portion for engaging surface portions of a pipe defining the port, and a cover portion for covering the port and defining said fill opening.

10. Apparatus according to claim 9 including a tubulation connected to said fill opening and terminating with said liquid fill coupling, and wherein said shut off valve and said liquid pressure gauge are disposed in said tubulation means between said fill coupling and said fill opening.

11. Apparatus according to claim 10 including a pressure regulator disposed in said tubulation between said fill coupling and said fill opening.

12. Apparatus according to claim 11 wherein said cap means further defines a drain opening defined by said cover portion and for communicating with the drainage system; and including a drain coupling connected to said drain opening.

13. Apparatus according to claim 12 including a cut off valve disposed between said drain coupling and said drain opening.

14. Apparatus according to claim 13 wherein said cup is a resilient member, and including a clamp for securing said cylindrical portion to surface portions of a pipe defining the port.

15. Apparatus according to claim 14 wherein said cover portion includes a tubular fill connector portion defining said fill opening.

16. Apparatus according to claim 15 wherein said fill opening faces one direction and said drain opening faces another direction transverse to said one direction.

17. Apparatus according to claim 1 including a cover for closing an opening at the most elevated position of the drainage system, said cover including a transparent tube communicating with the drainage system.

18. An apparatus according to claim 17 including a tubulation connected to said fill opening and terminating with said liquid fill coupling, and wherein said shut off valve and said liquid pressure gauge are disposed in said tubulation means between said fill coupling and said fill opening.

19. Apparatus according to claim 18 including a pressure regulator disposed in said tubulation between said fill coupling and said fill opening.

20. Apparatus according to claim 19 wherein said cap means further defines a drain opening for communicating with the drainage system; and including a drain coupling connected to said drain opening.

21. A method for leak testing a liquid drainage system and including the following steps:
providing a liquid pressure gauge and a cap means defining a liquid fill opening and supporting a liquid fill coupling communicating with said liquid fill opening;
closing a port in the liquid drainage system with the cap means;
attaching a liquid source to said liquid fill opening;
filling the liquid drainage system through the liquid fill opening while monitoring said liquid pressure gauge to establish a predetermined liquid pressure in the system; and
monitoring said liquid pressure gauge to detect leaks in the system indicated by a decrease in liquid pressure therein.

22. A method according to claim 21 wherein said cap means further supports a shut off valve disposed between said fill coupling and said fill opening; and including the step of closing said shut off valve when said predetermined liquid pressure is reached.

23. A method according to claim 21 wherein said cap means further defines a liquid drain opening; and including the step of draining the system through the drain opening after said monitoring step is completed.

24. A method according to claim 21 wherein said cap means further supports a liquid drain coupling connected to said drain opening and a cut off valve connected between said drain opening and drain coupling; and including the steps of closing said cut off valve during said filling and monitoring steps, and opening said cut off valve during said draining step.
